(19) United States
(12) Patent Application Publication
(10) Pub. No.: US 2023/0359974 A1
(43) Pub. Date: Nov. 9, 2023

(54) AD-HOC APPLICATION DEVELOPMENT

(71) Applicant: Kyndryl, Inc., New York, NY (US)

(72) Inventors: Gregory R. Hintermeister, Rochester, MN (US); Chris Moss, Brisbane (AU); Bryan M Buckland, Austin, TX (US)

(21) Appl. No.: 17/738,865

(22) Filed: May 6, 2022

(51) Int. Cl. G06Q 10/06

(52) U.S. Cl. CPC G06Q 10/06375

(57) ABSTRACT

A computer-implemented method, including: analyzing, by a computing device, historical information associated with a business application; determining, by the computing device, a business process based on the analyzed historical information; generating, by the computing device, a virtual reality simulation of the business process; identifying, by the computing device, a business application requirement based on a user interaction with the virtual reality simulation; and generating, by the computing device, the ad-hoc application based on the identified business application requirement.

### BACKGROUND

Aspects of the present invention relate generally to application development and, more particularly, to ad-hoc software application development using a virtual reality based system.

Business users often work with software developers to create software applications throughout the development process (e.g., design, development, testing, and deployment). At each stage, the development process is passed between business users and software developers, which may reduce efficiency and result in lost-in-translation points since neither party fully understands the other. Further, this iterative development process results in reduced efficiency due to the time taken from passing the software application. For example, business users provide their requirements to the developers. The developers then design and develop the software application and the application is then passed back to the business users for testing. Each of these transactions require communications that could be misunderstood and result in delays in the development process

### SUMMARY

In a first aspect of the invention, there is a computer-implemented method including: analyzing, by a computing device, historical information associated with a business application; determining, by the computing device, a business process based on the analyzed historical information; generating, by the computing device, a virtual reality simulation of the business process; identifying, by the computing device, a business application requirement based on a user interaction with the virtual reality simulation; and generating, by the computing device, an ad-hoc application based on the identified business application requirement.

In another aspect of the invention, there is a computer program product including one or more computer readable storage media having program instructions collectively stored on the one or more computer readable storage media. The program instructions are executable to: analyze historical information associated with a business application; determine an application usability for a business process based on the analyzed historical information; generate a relationship diagram of the business process based on the application usability; generate a virtual reality simulation of the business process; identify a business application requirement based on a user interaction with the virtual reality simulation; and generate an ad-hoc application based on the identified business application requirement.

In another aspect of the invention, there is system including a processor, a computer readable memory, one or more computer readable storage media, and program instructions collectively stored on the one or more computer readable storage media. The program instructions are executable to: analyze historical information associated with a software application; determine a business process based on the analyzed historical information; generate a virtual reality simulation of the business process; identify a business application requirement based on a user interaction with the virtual reality simulation; and generate an ad-hoc application based on the identified business application requirement.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary ad-hoc application development environment in accordance with aspects of the invention.

FIG. 5 shows a flowchart of an exemplary method in accordance with aspects of the invention.

FIG. 6 shows a chart of objects/entities and steps taken of another exemplary method in accordance with aspects of the invention.

### DETAILED DESCRIPTION

Aspects of the present invention relate generally to development of software applications and, more particularly, to development of software applications using a virtual reality (VR) system that utilizes machine learning and/or artificial intelligence (AI). In this manner, implementations of the invention provide ad-hoc development of software applications for a business process with new or identified business requirements. For example, an entire business process may be shown within a VR simulation, with business users interacting with the VR simulated business process to develop ad-hoc business applications based on business application requirements. Advantageously, in creating the VR simulation of a business process, the present invention (e.g., system, method and computer program product) may identify types of physical assets required by the business process and activities associated with the physical assets. And by taking into consideration these assets, an exact simulated environment in the VR system can be created such that using the VR system, users can visualize how the application is performing, how the data is generated, how the data is processed, etc.

In aspects of the invention, there is a method, system and computer program product for ad-hoc software application development using a VR system. The ad-hoc software application development may identify what types of physical assets the business process has and the activities with the physical assets, which are used to create an exact simulated environment in the VR system. Business application requirements can be specified in the VR environment, e.g., a business user may specify source data and how the source data is to be processed and consumed.

The ad-hoc software application development may include analyzing historical information about an application or a set of applications and creating VR visualization for an entire business process to present how the business process is performed by simulating the process within a VR environment. The historical information of the applications may be, e.g., application log, service tickets, service request application landscape information, application functionality, different types of sources of data, business logic on the code, source data systems, etc. The historical information may also be provided in a feedback loop used to identify relationships between business objects of the business process. In embodiments, the historical feedback loop may include computer modeling such as machine learning and/or natural language processing (NLP) models to determine business objects and processes. The terms “machine learning”, “machine learning model” and “machine learning processing” may denote methods of enabling a computer system to improve its capabilities automatically through experience and/or repetition without procedural programming. For example, machine learning algorithms build a mathematical model based on sample data, known as “training data”, to make predictions or decisions without being explicitly programmed to do so.

Accordingly, implementations of the invention provide an improvement in the technical field of application development by providing a technical solution to the known problems of business development requirements. For example, in embodiments, the technical solution may include, amongst other features: analyzing historical information associated with a business application; determining a business process based on the analyzed historical information; generating a VR simulation of the business process; identifying a business application requirement based on a user interaction with the VR simulation; and generating an ad-hoc application based on the identified business application requirement. The technical solution may also determine whether development of an ad-hoc application is possible based on the business application requirement and generate a relationship diagram for use in creation of objects in the VR simulation. These steps allow the ad-hoc application development to determine business requirements and needs for development of an application to meet those needs, and more efficiently provide users with a system to develop business applications in an ad-hoc manner.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

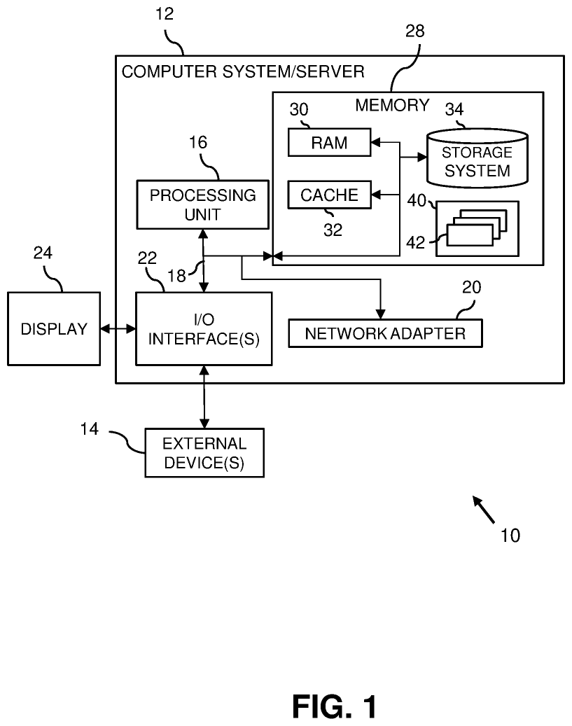

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

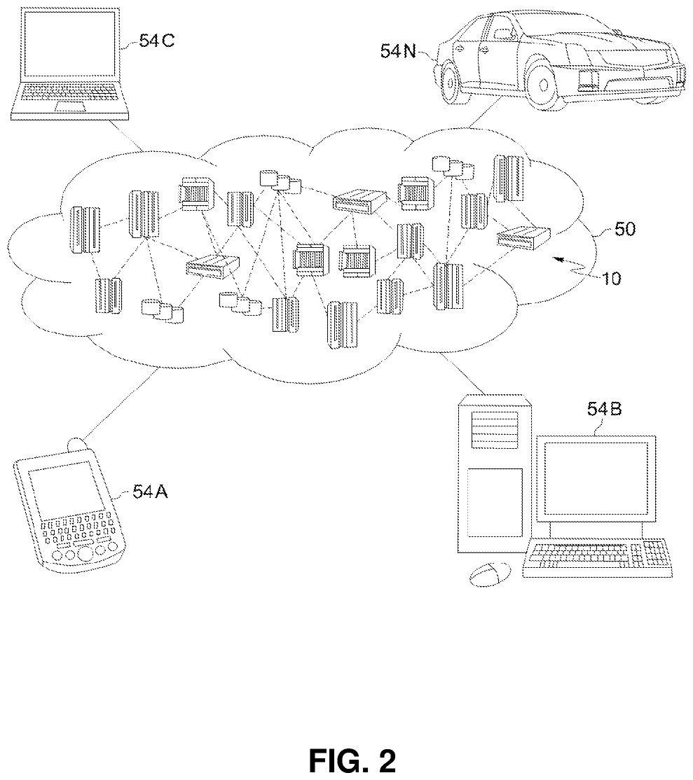

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

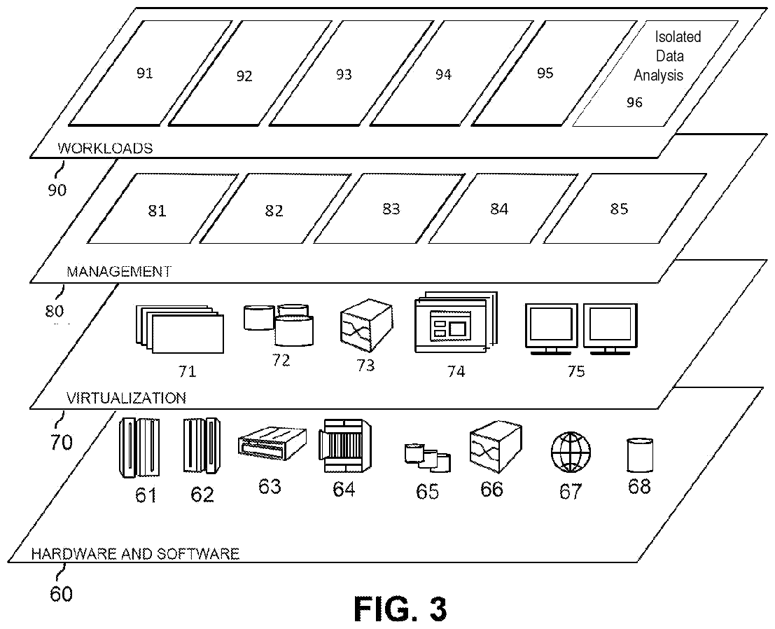

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and ad-hoc application development using VR 96.

Implementations of the invention may include a computer system/server 12 of FIG. 1 in which one or more of the program modules 42 are configured to perform (or cause the computer system/server 12 to perform) one of more functions of the ad-hoc application development using VR 96 of FIG. 3. For example, the one or more of the program modules 42 may be configured to, amongst other features:
(i) analyze historical information associated with a business application;
(ii) determine a business process based on the analyzed historical information;
(iii) generate a virtual reality simulation of the business process;
(iv) identify a business application requirement based on a user interaction with the virtual reality simulation; and
(v) generate an ad-hoc application based on the identified business application requirement.

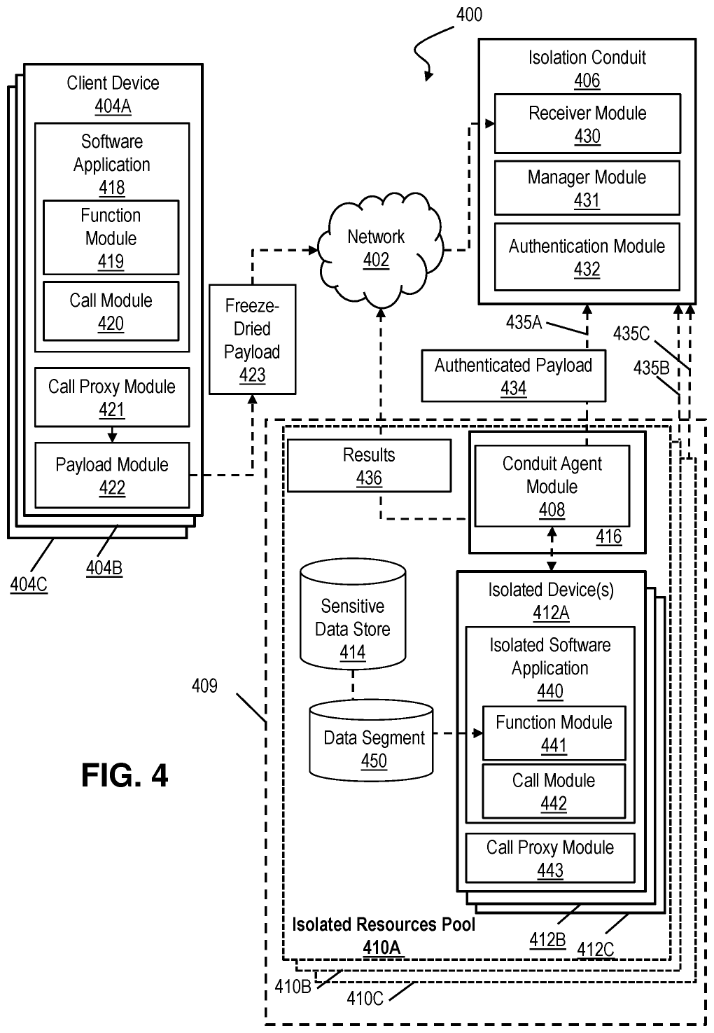

FIG. 4 shows a block diagram of an exemplary ad-hoc application development environment in accordance with aspects of the invention. In embodiments, the ad-hoc application development environment 400 includes a network 402 enabling communication between ad-hoc application development device 404, virtual reality (VR) simulation device 406, business services application device(s) 408, and client device(s) 410. In embodiments, the ad-hoc application development device 404, VR simulation device 406, the business services application device(s) 408 and the client device(s) 410 may each comprise a computing device (e.g., the computer system/server 12 of FIG. 1, or elements therefor) in a networked environment and/or a computing node 10 in the cloud computing environment 50 of FIG. 2 and/or one or more program modules such as program modules 42 described with respect to FIG. 1.

In embodiments, the VR simulation device 406 may simulate a business process along with business entities and data entities within a VR environment with which users may interact as described in more detail herein. The VR simulation device 406 may be a platform (i.e., one or more server computing devices) that hosts the VR environment upon which a VR simulation is created. The VR simulation device 406 may receive VR objects from the ad-hoc application development device 404 that represent parts of the business process to be used in the VR simulation. The business services application device(s) 408 includes one or more computing devices used by the business. The business services application device(s) 408 host the business applications that may be used by business entities during the course of business for various business processes. The client device(s) 410 include one or more computing devices that may be used by users to connect to and interact with VR objects of the VR environment in the VR simulation device 406.

In an example, the ad-hoc application development device 404 comprises one or more virtual machines (VMs) or one or more containers running on one or more server computing devices. In embodiments, the ad-hoc application development device 404 is configured to determine usability of a business application from business services application device(s) 408 by simulating a business process in a VR system. The usability of the business application indicates whether a business application is meeting the needs of the business users or when a change is needed to make the business application more efficient or effective for the business process. The business process is generated with business entities and transactions using a relationship diagram of the business process. The relationship diagram is a diagram that models, visualizes, and associates physical assets of the business (i.e., business entities), data entities, and transactions to describe the business process. Each relationship depicts interconnectedness of business entities, relationships, and their attributes. In embodiments, the relationship diagram may include tables or objects that represent business entities, attributes, and how the business entities are related. For example, the relationship diagram may be in a dictionary format table.

The ad-hoc application development device 404 generates a VR simulation of the business process which may be used to identify new business application requirements that require additions, changes, or updates to the business application based on user interactions with the VR system, e.g., objects in the VR simulation. The VR simulation includes VR objects and actions or transactions among the objects that are collected from the relationship diagram. The VR objects may include business entities, data entities, and the transactions themselves as objects in the VR simulation. Moreover, the business users can interact with the VR objects in the VR simulation to visualize the business process, thus allowing users to streamline, adjust and change the simulated business process as needed to reduce inefficiencies and provide additional, change, and/or remove steps in the process that may supplement and make the business process more efficient.

The ad-hoc application development device 404 also determines whether a business application can be developed and/or how the business application is developed. In exemplary embodiments, addition/change/removal templates (i.e., requirement template) may be used to determine whether the addition/change/removal can be generated in an ad-hoc application using an AI or machine learning modeling. For example, the machine learning model may be trained with historical business application requirements which are used to determine whether and/or to what extent an ad-hoc application may be developed without software developer input. The ad-hoc application development device 404 then generates the ad-hoc application based on the determination that the business application can be developed to address the business application requirement.

In exemplary embodiments, the requirement template may be used to determine whether the business application requirement can be met. In an exemplary embodiment, the requirement template takes the business application requirement as an input and based on historical knowledge or best estimates based on similarities, may output whether and to what extent the ad-hoc application can be developed. For example, if the business application requirement removes a step in the business application, the requirement template defines that this removal of a single step is capably developed with the ad-hoc application. The ad-hoc application development device 404 may use the requirement template to determine whether such a removal can be addressed with a generated ad-hoc application and thus generate the ad-hoc application without sending the business application requirement to a software developer.

The requirement template includes predefined knowledge of potential business application requirements in combination with the ad-hoc application(s) that may be developed to resolve these business application requirements. In embodiments, these combinations may also be defined based on the simplicity level of the business application requirement meeting a threshold simplicity. The simplicity level may be determined based on the type of business application requirement (e.g., an addition, change, removal, etc. of steps in the business application); a number of steps that are added, changed, and/or removed in the business application; and/or how much of the application is affected by the business application requirement (e.g., a percentage of the business application steps that are affected). The simplicity threshold may be predefined indicating a level of the business application requirement that can be met by prototyping and/or fully met by a generated ad-hoc application. For example, a business application requirement that adds multiple steps to a business application may require a prototyping to generate the ad-hoc application since the addition of many steps may have additional undesired effects on other parts of the business process.

In embodiments, the ad-hoc application development device 404 comprises business process analysis module 420, VR simulation generation module 421, application requirement module 422, development process module 423, and application development module 424, each of which may comprise one or more program modules such as program modules 42 described with respect to FIG. 1. The ad-hoc application development device 404 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments, the business process analysis module 420 is configured to analyze historical information associated with a business application or set of business applications. The business application(s) may be selected to streamline a business process. The historical information is used to identify the business process, key entities in the business process, and actions within a business process. In exemplary embodiments, the historical information may include information obtained from application log(s), service ticket(s), service request application landscape information (e.g., identifying application communication with other applications and sequence of data flow), application functionality (and how the functionality is achieved), types of sources of data used by the application, business logic on the code of the application (from software code analysis in relation to business requirements/entities/actions), and/or source data systems.

In embodiments, the sources of historical information may be used to generate a knowledge corpus of the business process by tracking how the application is performing, how the data used by the application is generated, and how the data used by the application is processed. One example of analysis of historical information includes identifying relevant information pertaining to entities of interest within a framework for transportation and warehouse applications using a system action application programming interface (API) (hereafter referred to as the “API”). The API may fetch relevant information from both applications (i.e., transportation and warehouse applications) related to the entities in both applications. For example, the information fetched from the applications may be about trucks transporting goods and cranes loading and unloading the trucks at the warehouse, as well as any communications between the two entities regarding loading/unloading times and locations.

In an exemplary embodiment, the analysis may be supported by artificial intelligence or machine learning processing to identify parts of the business process. The historical information may be input into the machine learning processing to determine a business process and to train the machine learning processing. For example, the machine learning process may use relationship diagramming with a unified modeling language (UML) to aid in determining relationships between business entities and data elements of the business process. In particular, the UML helps to describe objects (e.g., business entities and data elements) in the business process and how they are used. The UML may also generate a visualization of the business process through describing relationships between objects/entities. Continuing the example above of the API, dependency modules pertaining to the transportation and warehouse applications are stored in a dictionary format as a payload for use by the UML. For example, a warehouse loading arm may transfer a package from a transport vehicle for placement at a scanning device. The arm may then pass the package to another location in the warehouse for storage. A business user may interact with each of these business entities, e.g., the loading arm, and determine that the scanning can occur anywhere in the warehouse and the scanning location placement may be removed as a step in the business process. In other words, the removal of the scanning placement may be a business application requirement that can be generated in an ad-hoc business application.

Service ticket(s) may include service requests from business users which identifies requirements implemented in the application. Service ticket(s) may, for example, include requests for enhancements by business users. For example, the analysis of historical information may include using known tools for tracking historical use of applications such as with respect to service ticket(s). The application log(s), service request application landscape information, and source data systems may be used to identify data flow logic from application code and how different applications communicate with one another, application workflow, and objects of a business process. Continuing the example above regarding the API, network traffic flow between applications can be monitored via known network protocol analyzers (i.e., Wireshark™ which is a trademark owned by Wireshark) at a time instant for a given entity. Further, distances between the entities may be requested by a user to determine relationships and identify or extract an intent of actions by the entities. For example, the transportation application may pass location information to the warehouse application for package pickup. In this example, for instance, if the transportation application sends location information and date/time for pickup separately over the network, these two packets of information may be reduced to one as a business application requirement and addressed by another ad-hoc business application.

In embodiments, the VR simulation generation module 421 is configured to create the VR model of the application or set of applications by creating VR objects for use in the VR simulation device 406. The VR objects are of physical assets (e.g., business entities), data elements, and sources and interactions with the data elements of the business process as received from the business process analysis module 420. The business process analysis module 420 may also be used to determine physical assets of the business used by the application (including, e.g., machines, vehicles, computers, etc.) and to map the physical asset to data elements of the application. For example, a physical asset may include vehicles, cranes, warehouses, etc. used during a business process and may be created as a VR object in the VR model. In an exemplary embodiment, the data elements without a physical identity such as a customer, time, etc. may be assigned a VR object. For example, a customer may be shown as a human identity VR object.

The generated VR model simulates the entire business process and how it works as identified from the application. Continuing the example above regarding the API, a VR simulation A-frame (i.e., a web framework for VR experiences) is generated for any known VR simulation application. The VR simulation A-frame uses a domain object model (DOM); however, this may not reach the level of the browser layout engine. The use of this DOM allows built (i.e., generated) VR objects to be updated in computing memory with little overhead. Further, a tag may be appended to the A-frame which handles 3D boilerplate, VR setups, and default controls for the VR simulation as is known in the art. In this manner, a VR simulation is created.

In embodiments, the application requirement module 422 is configured to gather information about interactions of business users within the VR model in VR simulation device 406. In an exemplary embodiment, a business user may provide additional sources of data that may affect the VR model, e.g., news sources, weather information, and permissions to access different data sources. In an exemplary embodiment, the business users may interact with the VR model by navigating to different VR objects and interacting with the VR objects to define where data is gathered, and how data is used/consumed. These new sources of data or objects may be included in the VR simulation as changes/additions that increases the effectiveness of the business process. For example, a business process may change due to weather, thus the new source of data may include information from weather sources (e.g., the National Weather Service) which may affect the timing of loading/unloading a truck at a warehouse.

In exemplary embodiments, business user interactions may include gesture-based and voice command interactions. Gestures may include movement of the business user including hand movements. For example, a user may want to expand on details of a VR object in the VR simulation by doing a spreading hand movement. Or in another gesture, a swiping movement to move the VR object to a different location may be advantageous. In an exemplary embodiment, voice commands or interactions may be recorded at the VR simulation device 406 for analysis through a natural language processing (NLP). Business user interactions may also include a collaboration by more than one business user. These interactions may indicate business requirements that are missing from the business application. For example, interactions that often transfer a data element to a first physical asset and then to a second physical asset before use during the business process may indicate a lack of efficiency that could be fixed by adjusting the data element prior to use by the second physical asset. This information can be used to bypass passing of the data element to the first physical asset and hence increase the efficiency of the business process. Other interactions may include direct service requests or business user requests through voice to fix or adjust something during the business process.

In embodiments, the development process module 423 is configured to determine whether an ad-hoc application may be developed to meet the business requirement(s). In embodiments, the development process module 423 also determines to what extent the ad-hoc application may be developed, i.e., fully developed, a prototype can be created, and whether a software developer is required. In embodiments, this determination may be supported by artificial intelligence or machine learning processing to iteratively determine development capabilities of the ad-hoc application.

In embodiments, the application development module 424 is configured to take action as determined by the development process module 423. For example, if a complete ad-hoc application or prototype application can be created, application development module 424 will perform such an action. Similarly, the application development module 424 may also request and/or notify a software developer when required, for example when neither prototyping or complete ad-hoc creation of an application is possible to meet the needs of the business application requirement.

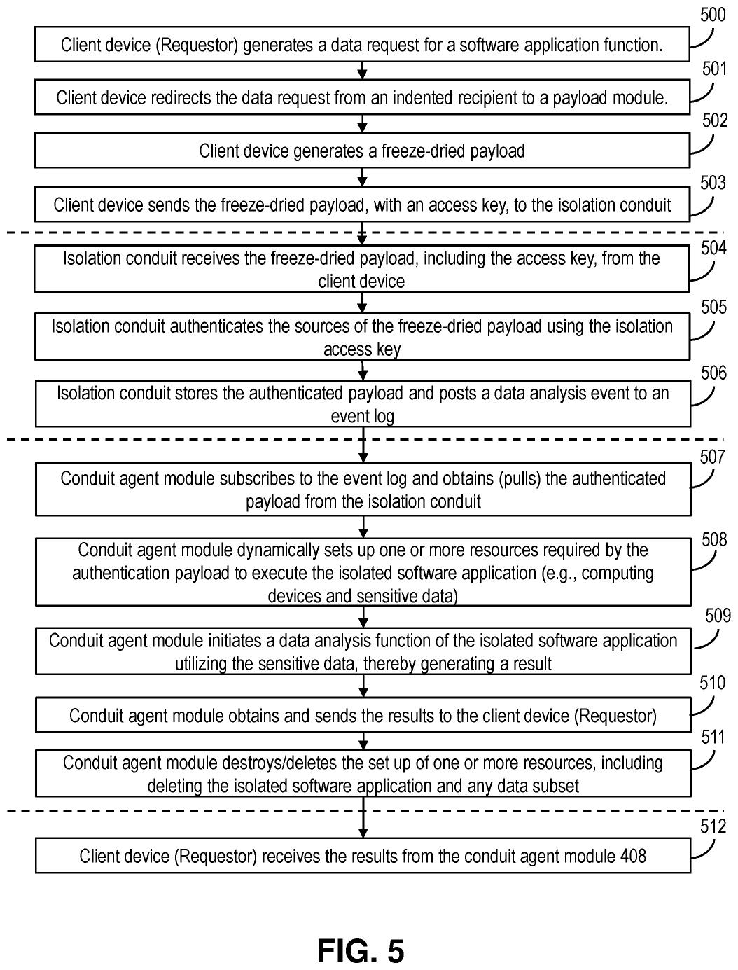

FIG. 5 shows a flowchart of an exemplary method in accordance with aspects of the present invention. Steps of the method may be carried out in the environment of FIG. 4 and are described with reference to elements depicted in FIG. 4. At step 501, the system (e.g., ad-hoc application development device 404 of FIG. 4) analyzes historical information associated with a business application and determines a business process based on the analyzed historical information. At step 503, the system generates a relationship diagram of the business process. In an exemplary embodiment, the relationship diagram determines objects that are a part of the business process. At step 505, the system generates a VR simulation of the business process. The determined objects that are part of the business process may be used to identify physical assets, business activities using the physical assets, data elements that have no physical equivalent, and how each object is used in the business application (i.e., business activities) throughout the business process.

At step 507, the system identifies a business application requirement based on a user interaction with the VR simulation. Business users may interact with the VR simulation to directly address or indicate business application requirements of the business process/application, specify data sources, and how the data sources will be processed.

At step 509, the system determines whether development of an ad-hoc application is possible based on the business application requirement. In an exemplary embodiment, the ad-hoc development process identifies and integrates various components of an ad-hoc business application to meet the business application requirement(s). The business application requirement is identified from a pre-defined template. If any information is missing from the pre-defined template, the system may request such information from a business user.

At step 511, the system generates the ad-hoc application based on the determination that the ad-hoc application is possible. In an exemplary embodiment, the ad-hoc application is validated, i.e., meets the business application requirements, such that development can begin. Such a validation may include use of machine learning processing to identify whether a business application requirement is met at different development levels. The development levels may include whether the business application requirement can be met fully with a developed completed ad-hoc application, partially met with the development of the application through an initial prototyping, or cannot be met at all using the ad-hoc application development device 404, i.e., requires a software developer to create the ad-hoc application.

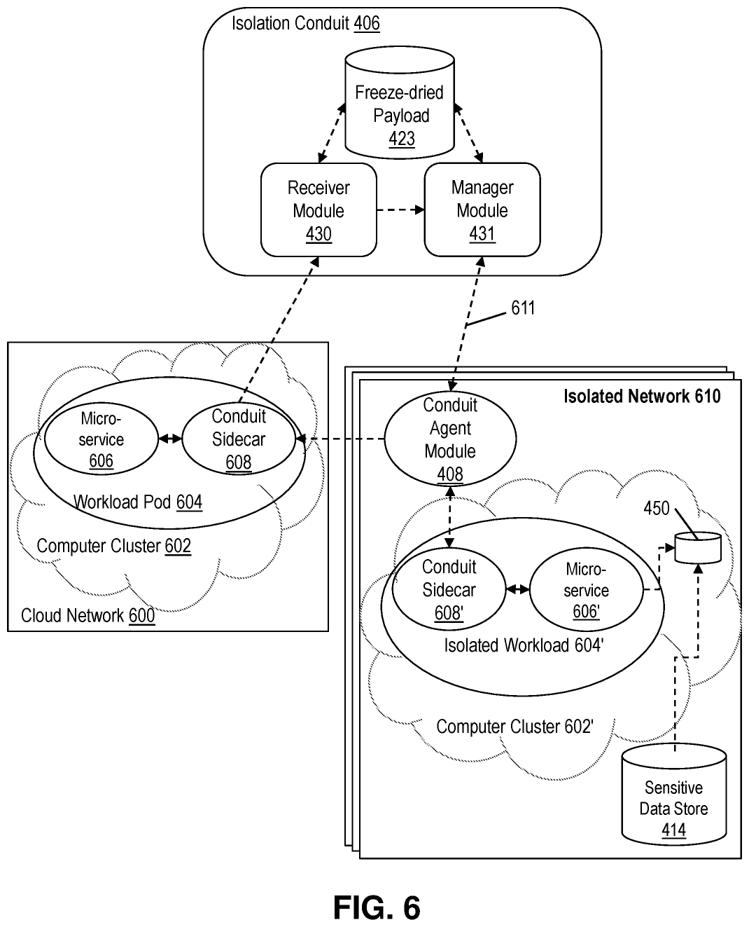

FIG. 6 shows a chart of objects/entities and steps taken by an exemplary method in accordance with aspects of the present invention. Steps of the method may be carried out in the environment of FIG. 4 and are described with reference to elements depicted in FIG. 4.

Entities 601A (i.e., warehouse application) and 601B (i.e., transportation application) are applications that are selected for analysis for business processes. The applications 601A and 601B are analyzed at step 603 by identifying sources of historical information, physical assets used, any tickers (e.g., requested service tickets), application workflows, application functions, types of data used by the application, and a source code analysis of the application for identifying relationships between entities and data elements within a business process. At step 605, the user may validate use of particular identified sources, and at step 607, the AI system may model the business process by creating objects that may be input into a VR content generation module which, at step 609, will create the VR model of the business process (shown at step 611). In embodiments, the AI system uses the information obtained from step 603 in its modeling.

Once the VR model is created, user interactions with the VR model may be tracked and used to identify business application requirements at step 613. Interactions may include spoken content that is recorded and sent to the ad-hoc application development device 404 for analysis. At step 615, the business application requirement is entered into a template to help determine whether the business application requirement can be developed. The template may include types of business application requirements and an ad-hoc application type that may meet the needs of the business application requirement. The business application requirement is also validated by a business user. Further, a determination is made regarding how an ad-hoc application can be developed at step 617.

In embodiments, at step 619, an AI system is used to validate and determine what steps can be taken to create an ad-hoc application. For instance, the interaction information may be entered into the AI system to iteratively determine the closest business application requirement based on the interaction information. Initially, business users may be asked to validate whether the business application requirement they were contemplating is based on the interactions. Additionally, the AI system may iteratively determine, based on the business application requirement, what type of ad-hoc application may meet the needs of the business application requirements and determine whether, based on the requirements, the ad-hoc application can be fully created or prototyped without software developer inputs. It is noted, the AI system of step 607 and the AI system of step 619 need not be the same system, but could be the same system as long as the AI system can be configured to do both steps (607 and 619). At step 621, the ad-hoc application development device 404 develops the ad-hoc application.

In embodiments, a service provider could offer to perform the processes described herein. In this case, the service provider can create, maintain, deploy, support, etc., the computer infrastructure that performs the process steps of the invention for one or more customers. These customers may be, for example, a business that uses business applications during the course of business to execute business processes. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
analyzing, by a computing device, historical information associated with a business application;
determining, by the computing device, a business process based on the analyzed historical information;
generating, by the computing device, a virtual reality simulation of the business process;
identifying, by the computing device, a business application requirement based on a user interaction with the virtual reality simulation; and
generating, by the computing device, an ad-hoc application based on the identified business application requirement.

2. The computer-implemented method of claim 1, further comprising determining whether development of the ad-hoc application is possible based on the business application requirement.

3. The computer-implemented method of claim 1, wherein the historical information comprises information obtained from at least one of:
an application log,
service tickets,
service request application landscape information,
application functionality of the business application,
types of sources of data,
business logic in source code of the business application, and
source data systems.

4. The computer-implemented method of claim 1, wherein the generating of the virtual reality simulation further comprises:
generating a relationship diagram of the business process;
identifying physical assets from the relationship diagram; and
identifying business activities using the identified physical assets.

5. The computer-implemented method of claim 1, wherein the user interaction includes voice and/or gesture input.

6. The computer-implemented method of claim 5, wherein the voice is analyzed using a natural language processing.

7. The computer-implemented method of claim 1, wherein the identifying of the business application requirement includes using selected sources of data.

8. The computer-implemented method of claim 1, further comprising:
determining a development level of the ad-hoc application based on the business application requirement.

9. The computer-implemented method of claim 1, wherein the analyzing uses a machine learning process on the historical information to establish the business process.

10. The computer-implemented method of claim 9, further comprising:
modeling the ad-hoc application development by identifying and integrating different components to meet the business application requirement.

11. The computer-implemented method of claim 1, wherein the user interaction includes collaborative user interaction.

12. The computer-implemented method of claim 1, wherein the computing device includes software provided as a service in a cloud environment.

13. A computer program product comprising one or more computer readable storage media having program instructions collectively stored on the one or more computer readable storage media, the program instructions executable to:
analyze historical information associated with a business application;
determine an application usability for a business process based on the analyzed historical information;
generate a relationship diagram of the business process based on the application usability;
generate a virtual reality simulation of the business process;
identify a business application requirement based on a user interaction with the virtual reality simulation; and
generate an ad-hoc application based on the identified business application requirement.

14. The computer program product of claim 13, wherein the program instructions are further executable to determine whether development of the ad-hoc application is possible based on the business application requirement.

15. The computer program product of claim 13, wherein the historical information comprises information obtained from at least one of:
an application log,
service tickets,
service request application landscape information,
application functionality of the business application,
types of sources of data,
business logic in source code of the business application, and
source data systems.

16. The computer program product of claim 13, wherein the generation of the virtual reality simulation further comprises:
identify physical assets from the relationship diagram; and
identify business activities using the identified physical assets.

17. A system comprising:
a processor, a computer readable memory, one or more computer readable storage media, and program instructions collectively stored on the one or more computer readable storage media, the program instructions executable to:
analyze historical information associated with a software application;
determine a business process based on the analyzed historical information;
generate a virtual reality simulation of the business process;
identify a business application requirement based on a user interaction with the virtual reality simulation; and
generate an ad-hoc application based on the identified business application requirement.

18. The system of claim 17, wherein the program instructions are further executable to determine whether development of the ad-hoc application is possible based on the business application requirement

19. The system of claim 17, wherein the historical information comprises information obtained from at least one of:
an application log,
service tickets,
service request application landscape information,
application functionality of the software application,
types of sources of data,
business logic in source code of the software application, and
source data systems.

20. The system of claim 17, wherein the generation of the virtual reality simulation further comprises program instructions that are further executable to:
generate a relationship diagram of the business process;
identify physical assets from the relationship diagram; and
identify business activities using the identified physical assets.
